(19) United States
(12) Patent Application Publication
(10) Pub. No.: US 2010/0164977 A1
(43) Pub. Date: Jul. 1, 2010

(54) IMAGE DISPLAY APPARATUS AND METHOD FOR CORRECTING OUTPUT IMAGE

(76) Inventor: Hirotoshi Miyazawa, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/603,291

(22) Filed: Oct. 21, 2009

(30) Foreign Application Priority Data
Dec. 25, 2008 (JP) 2008-331345

(51) Int. Cl. G09G 5/02; G09G 5/00

(52) U.S. Cl. 345/595; 345/581

(57) ABSTRACT

According to one embodiment, an image display apparatus includes a display module configured to display an image, a reference image display controller configured to control display of a reference image performed by the display module, a reader configured to read acquired image data including the reference image displayed by the display module and an image of a surrounding area of the display module, and a correction module configured to detect the acquired images of the reference image and the surrounding area in the acquired image data and to correct an output image output by the display module based on the reference image, the acquired image of the reference image, and the acquired image of the surrounding area.

### CROSS-REFERENCE TO RELATED APPLICATIONS

This application is based upon and claims the benefit of priority from Japanese Patent Application No. 2008-331345, filed Dec. 25, 2008, the entire contents of which are incorporated herein by reference.

### BACKGROUND

1. Field

One embodiment of the invention relates to an image display apparatus capable of correcting output images, and a method for correcting an output image.

2. Description of the Related Art

In recent years, with high-definition television broadcasting well under way, TVs that are compatible with high-definition (HD) standards have become common in general households. Viewers desire to view programs under better conditions.

How TV screen display appears varies depending on, for example, the brightness of a room. Jpn. Pat. Appln. KOKAI Publication No. 2001-5437 (Document 1) discloses a technique of using a video camera to acquire an image of a surrounding environment and detecting the brightness and color temperature of the surrounding environment in a signal for the acquired image to control image display.

Jpn. Pat. Appln. KOKAI Publication No. 2007-174229 (Document 2) discloses a technique of using a camera to obtain image data, calculating the color temperature of the surrounding area based on the image data, and generating a video signal based on the color temperature and a video source to display a video.

The techniques disclosed in Documents 1 and 2 allow image display to be controlled based on the color temperature of the surrounding area or the like. However, viewers do not directly perceive the colors of actual image display but may experience an optical illusion. For example, the color of the surrounding area (a wall or the like) in the image display may affect the manner in which the image display appears to the human eye. Neither Document 1 nor Document 2 discloses a technique of controlling the image display with the adverse effect of the color of the surrounding area of the image display taken into account.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram showing how an image of a screen and a surrounding area is acquired using an image acquisition apparatus;

FIG. 2 is a diagram showing a menu screen containing an item for viewing environment measurement according to an embodiment of the invention;

FIG. 3 is a diagram showing an image acquired by the image acquisition apparatus according to the embodiment;

FIG. 4 is a diagram showing a guidance screen showing a viewer how to perform an operation of specifying the position of a screen according to the embodiment;

FIG. 5 is a diagram showing a guidance screen showing the viewer how to perform an operation of specifying the position of a wall surrounding the screen according to the embodiment;

FIG. 6 is a diagram schematically showing the configuration of a digital television broadcast receiving apparatus according to the embodiment; and

FIG. 7 is a flowchart showing an output image correcting process according to the embodiment.

### DETAILED DESCRIPTION

Various embodiments according to the invention will be described hereinafter with reference to the accompanying drawings. In general, an image display apparatus according to one embodiment comprises a display module configured to display an image, a reference image display controller configured to control display of a reference image performed by the display module, a reader configured to read acquired image data including the reference image displayed by the display module and an image of a surrounding area of the display module, and a correction module configured to detect the acquired images of the reference image and the surrounding area in the acquired image data and to correct an output image output by the display module based on the reference image, the acquired image of the reference image, and the acquired image of the surrounding area.

An embodiment of the present invention will be described below with reference to the drawings.

FIG. 6 is a diagram schematically showing the configuration of a digital television broadcast receiving apparatus (image display apparatus) according to an embodiment of the present invention.

FIG. 6 shows a main signal processing system in the above-described digital television broadcast receiving apparatus 100. That is, a digital direct-broadcast satellite (DBS) television signal is received by a digital DBS receiving antenna 47. The digital DBS television signal is then supplied to a digital DBS tuner 49 via an input terminal 48. The tuner 49 then selects a broadcasting signal for a desired channel from the digital DBS television signal.

The broadcasting signal selected by the tuner 49 is supplied to a phase-shift keying (PSK) demodulation module 50. The PSK demodulation module 50 demodulates the broadcasting signal into a digital video signal and a digital audio signal and outputs the video and audio signals to a signal processing module 51.

Furthermore, a terrestrial digital television broadcasting signal is received by a terrestrial broadcasting receiving antenna 52. The terrestrial digital television broadcasting signal is then supplied to a terrestrial digital broadcasting tuner 54 via an input terminal 53. The tuner 54 then selects a broadcasting signal for a desired channel from the terrestrial digital television broadcasting signal.

The broadcasting signal selected by the tuner 54 is supplied to an orthogonal frequency division multiplexing (OFDM) demodulation module 55. The OFDM demodulation module 55 then demodulates the broadcasting signal into a digital video signal and a digital audio signal and outputs the video and audio signals to the signal processing module 51.

Additionally, a terrestrial analog television broadcasting signal is received by the terrestrial broadcasting receiving antenna 52. The terrestrial analog television broadcasting signal is then supplied to a terrestrial analog broadcasting tuner 56 via an input terminal 53. The tuner 56 then selects a broadcasting signal for a desired channel from the terrestrial analog television broadcasting signal. The broadcasting signal selected by the tuner 56 is supplied to an analog demodulation module 57. The analog demodulation module 57 then demodulates the broadcasting signal into an analog video signal and an analog audio signal and outputs the video and audio signals to the signal processing module 51.

Then, the signal processing module 51 selectively carries out predetermined digital signal processing on the digital video and audio signals supplied by the PSK demodulation module 50 and the OFDM demodulation module 55. The signal processing module 51 outputs the resulting signals to a graphic processing module 58 and an audio processing module 59, respectively.

A plurality of input terminals (in FIG. 6, four: 60a to 60d) are connected to the signal processing module 51. The input terminals 60a to 60d allow external analog video and audio signals to be input to the digital television broadcast receiving apparatus 100.

The signal processing module 51 selectively digitizes analog video and audio signals supplied by the analog demodulation module 57 and the input terminals 60a to 60d. The signal processing module 51 then carries out predetermined digital signal processing on the digitized video and audio signals and outputs the resulting signals to the graphic processing module 58 and the audio processing module 59, respectively.

The graphic processing module 58 has the function of superimposing an on-screen display (OSD) signal generated by an OSD signal generation module 61, on a digital video signal supplied by the signal processing module 51 and outputting the resulting signal. The graphic processing module 58 can selectively output the output video signal from the signal processing module 51 and the output OSD signal from the OSD signal generation module 61. The graphic processing module 58 can also combine and output both outputs so that each of the outputs makes up half of the screen.

The digital video signal output by the graphic processing module 58 is supplied to a video processing module 62. The video processing module 62 processes the video signal and supplies the processed video signal to a video display 14 and an output terminal 63. The video display 14 displays a video based on the video signal. When an external apparatus is connected to the output terminal 63, the video signal supplied to the output terminal 63 is input to the external apparatus.

The audio processing module 59 converts the input digital audio signal into an analog audio signal in a format in which the signal can be reproduced by a speaker 15. The audio processing module 59 outputs the analog audio signal to the speaker 15, which then reproduces a sound and also guides the sound to an external apparatus via an output terminal 64.

In this case, all the operations of the digital television receiver 100 including the above-described various receiving operations are integrally controlled by a controller 65. The controller 65 contains a central processing unit (CPU) and the like. The controller 65 controls the modules so as to reflect the contents of operation information received from an operation module 16 or operation information transmitted by a remote controller 17 and received via a light receiving module 18.

In this case, the controller 65 mainly uses a read-only memory (ROM) 66 in which control programs executed by the CPU are stored, a random access memory (RAM) 67 providing a work area for the CPU, and a nonvolatile memory 68 in which various pieces of setting information, control information, and the like are stored.

The controller 65 is connected, via a card interface 69, to a card holder 70 in which a first memory card 19 can be installed. Thus, the controller 65 can transmit and receive information to and from the first memory card 19 installed in the card holder 70, via the card interface 69.

The controller 65 is also connected, via a card interface 71, to a card holder 72 in which a second memory card 20 can be installed. Thus, the controller 65 can transmit and receive information to and from the second memory card 20 installed in the card holder 72, via the card interface 71.

The controller 65 is also connected to a LAN terminal 21 via a communication interface 73. Thus, the controller 65 can transmit and receive information to and from a LAN compatible apparatus connected to the LAN terminal 21, via the communication interface 73. In this case, the controller 65 has a Dynamic Host Configuration Protocol (DHCP) server function. The controller 65 assigns, for control, an Internet Protocol (IP) address to the LAN compatible apparatus connected to the LAN terminal 21.

The controller 65 is also connected to a first HDMI terminal 22 via a first HDMI interface 74. Thus, the controller 65 can transmit and receive information to and from an HDMI compatible apparatus connected to the first HDMI terminal 22, via the first HDMI interface 74. The controller 65 is further connected to a second HDMI terminal 23 via a second HDMI interface 75. Thus, the controller 65 can transmit and receive information to and from an HDMI compatible apparatus connected to the second HDMI terminal 23, via the second HDMI interface 75.

The controller 65 is also connected to a USB terminal 24 via a USB interface 76. Thus, the controller 65 can transmit and receive information to and from a USB compatible apparatus connected to the USB terminal 24, via the USB interface 76.

The controller 65 is further connected to a LINK terminal 25 via an i.Link interface 77. Thus, the controller 65 can transmit and receive information to and from an i.Link compatible apparatus connected to the i.Link terminal 25, via the i.Link interface 77.

A brightness detection module 80 is provided, for example, flush with the video display surface of the video display 14 to detect the brightness of an area in which the digital television broadcast receiving apparatus 100. Brightness information (the value of ambient illuminance) detected by the brightness detection module 80 is transmitted to the controller 65, which then uses the information to correct output images as described below.

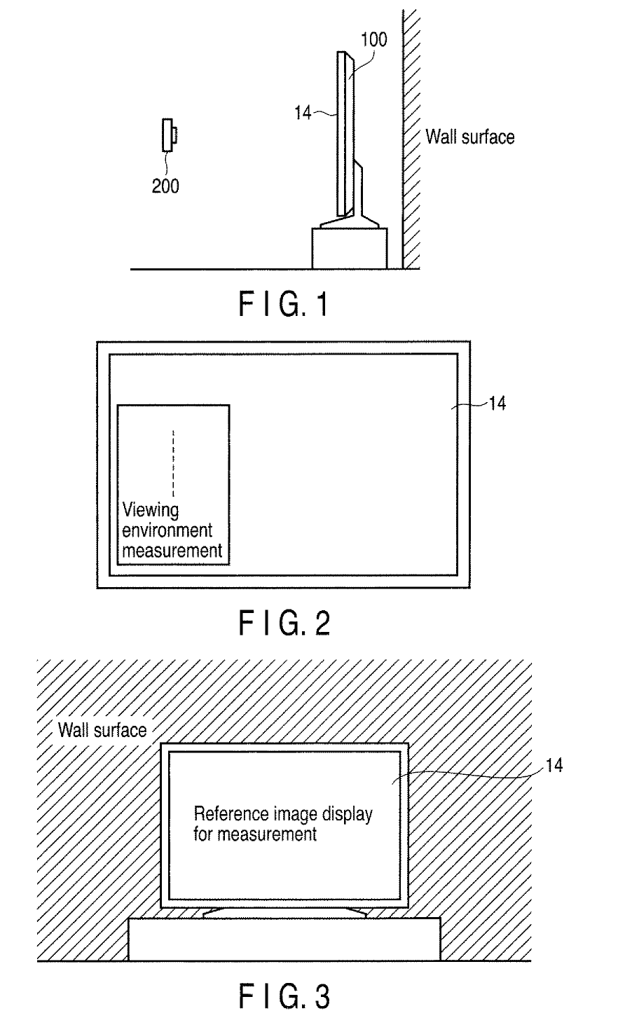

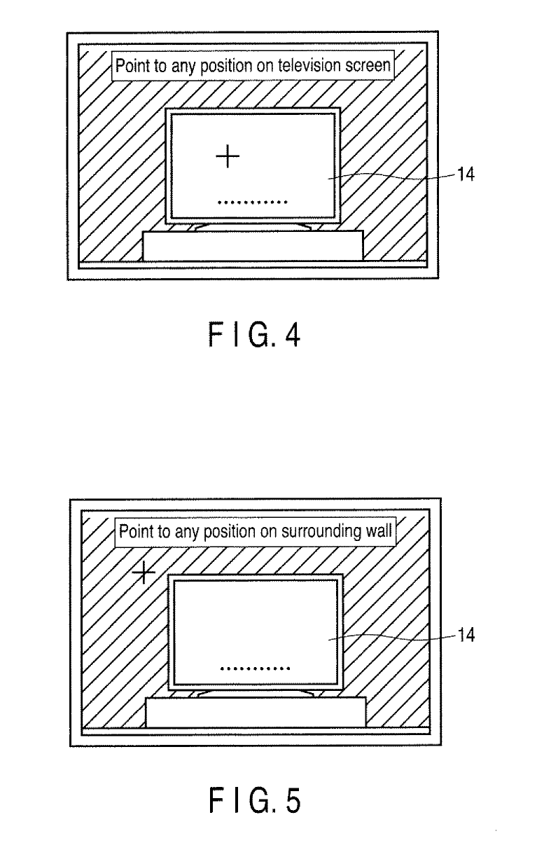

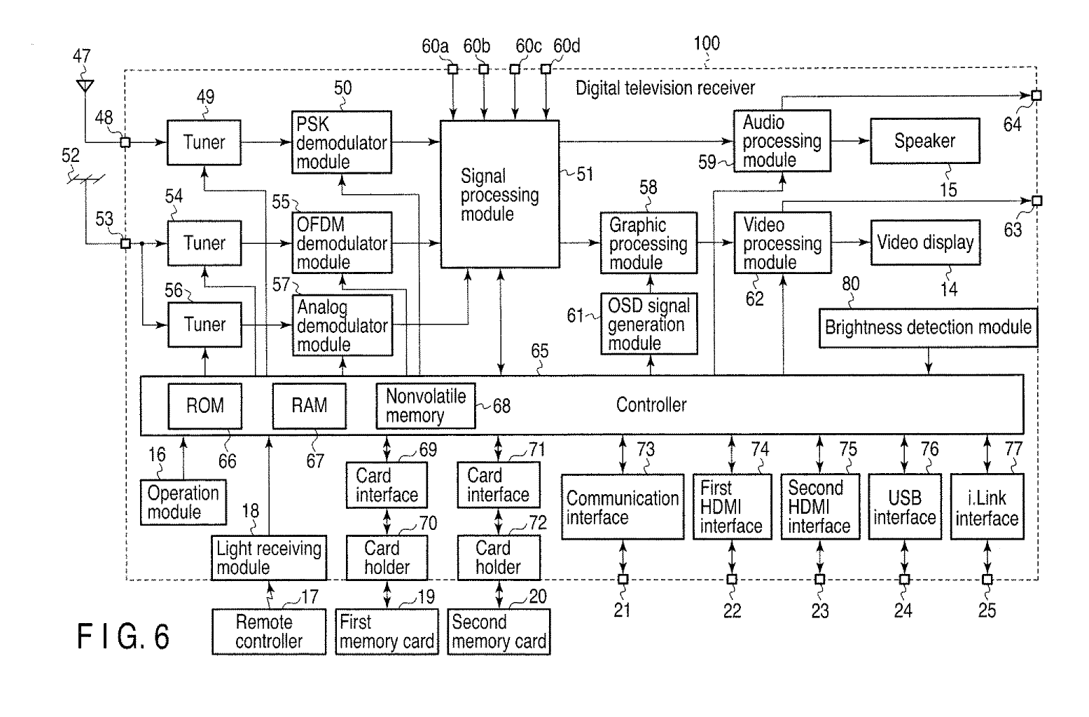

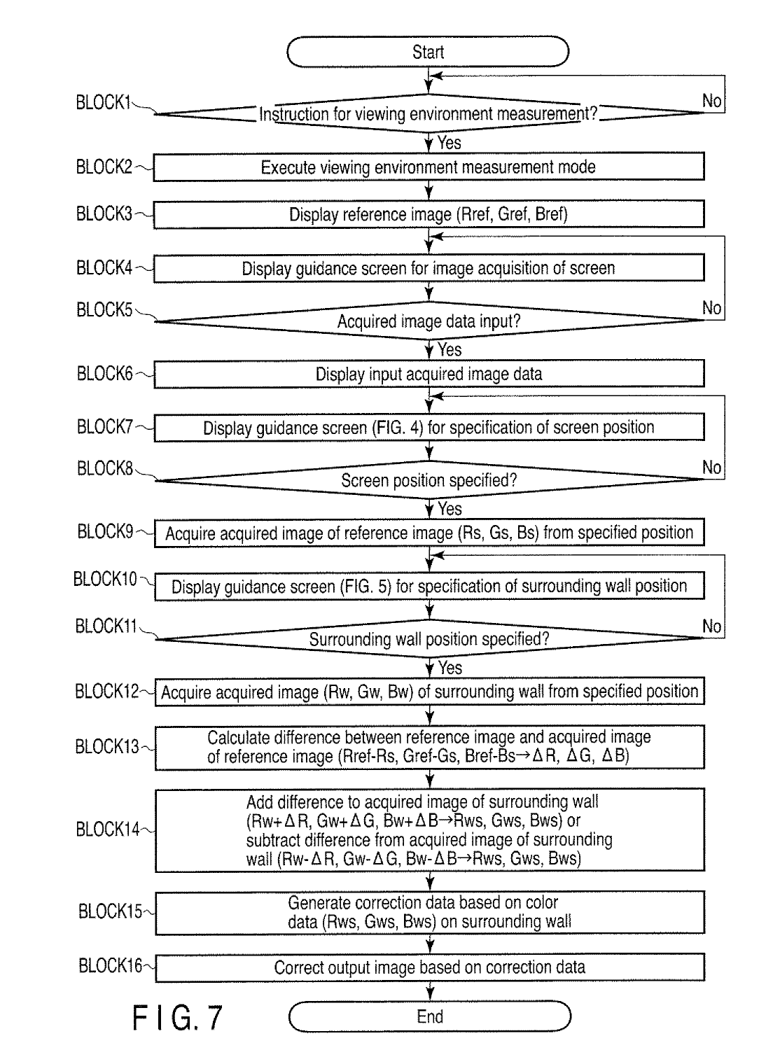

Now, with reference to FIGS. 1 to 7, correction of output images from the above-described digital television broadcast receiving apparatus will be described. FIG. 1 is a diagram showing an example of installation of the digital television broadcast receiving apparatus. FIG. 2 is a diagram showing an example of a menu screen displayed by the digital television broadcast receiving apparatus. FIG. 3 is a diagram showing an example of a acquired image of the digital television broadcast receiving apparatus and a surrounding area. FIG. 4 is a diagram showing an example of a user input operation performed to acquire a reference image required to correct output images. FIG. 5 is a diagram showing an example of a user input operation performed to acquire an image of a surrounding wall required to correct output images. FIG. 7 is a flowchart showing an example of a process of correcting output images.

To allow output images to be properly corrected, conditions for room illumination and conditions for external light may be set. For example, the user gives an instruction to display a menu screen. In response to the instruction, the controller 65 instructs the OSD signal generation module 61 to display the menu screen. The OSD signal generation module 61 generates and outputs an OSD signal required to display the menu screen. Thus, the menu screen is displayed on the video display 14. The menu screen contains, for example, an item for environment setting.

When the user selects the item for environment setting via the operation module 16 or the remote controller 17, the video display 14 displays an item for setting of the conditions for the room illumination (a selection item including a fluorescent lamp or an incandescent lamp) and an item for setting of external light conditions (a selection item including external light present or no external light). The user can set the conditions for the room illumination and the conditions for external light via the operation module 16 or the remote controller 17. The nonvolatile memory 68 stores the set conditions for room illumination and the set conditions for external light.

The menu screen also contains a large number of items as shown by a dotted line in FIG. 2. The large number of items include one for viewing environment measurement. The user desiring to correct an output image selects the item for viewing environment measurement from the menu screen via the operation module 16 or the remote controller 17 (BLOCK 1, YES). In response, the controller 65 carries out a viewing environment measurement mode (image correction mode) (BLOCK 2). The controller 65 thus controls an operation of displaying the reference image required for image correction and reading of acquired image data required for the image correction, calculates correction data required for the image correction, and controls the image correction based on the calculation results.

The controller 65 controls the display of an appropriate reference image (Rref, Gref, Bref) based on the value of the ambient illuminance detected by the brightness detection module 80, the current time, and the conditions for the room illumination and the conditions for external light stored in the nonvolatile memory 68. In response, the video processing module 62 generates a reference images, and the video display 14 displays the reference images (BLOCK 3). The video display 14 shows, for example, a white reference image based on a white signal. Alternatively, a color bar may be the reference image. In the description of the present embodiment, the conditions for the room illumination and the conditions for external light are preset. However, the conditions for the room illumination and the conditions for external light may be set after the viewing environment measurement mode is carried out.

The controller 65 further controls display of a guidance screen for screen image acquisition. In response to the control, the video display 14 shows the guidance screen for screen image acquisition (BLOCK 4). For example, the guidance screen on the video display 14 shows the text “Acquire an image of the screen (reference image) currently displayed on your digital camera or cellular phone, together with the surrounding area (surrounding wall) of the screen, and input the acquired image data”.

Subsequently, as shown in FIG. 1, the user uses an image acquisition apparatus 200 such as a digital still camera, a digital video camera, or a cellular phone to acquire an image of the screen (video display 14) on which the reference image is displayed, together with the surrounding area (surrounding wall) of the screen. The user then inputs the acquired image data obtained to the digital television broadcast receiving apparatus 100 (BLOCK 5, YES). In general, the image acquisition apparatus 200 includes the image correcting function of adjusting white balance or the like. This allows the acquired image data obtained by the image acquisition apparatus 200 to be subjected to image correction. If no acquired image data is input for a given period (BLOCK 5, NO), the guidance screen is shown again on the video display 14 (BLOCK 4). During image acquisition, the visual range obtained when the user actually watches television is desirably almost the same as the angle of view of the acquired image. FIG. 3 is a diagram showing an example of a acquired image.

If the image acquisition apparatus 200 is of a type in which acquired image data is recorded in a removable memory card, the acquired image data stored in the memory card is input to the digital television broadcast receiving apparatus 100 via the card holder 70 or 72. Alternatively, if the image acquisition apparatus 200 is of a type including a USB terminal, the acquired image data stored in the image acquisition apparatus 200 is input to the digital television broadcast receiving apparatus 100 via the USB interface 76. Alternatively, if the image acquisition apparatus 200 is of a type including an i.LINK interface 77, the acquired image data stored in the image acquisition apparatus 200 is input to the digital television broadcast receiving apparatus 100 via the i.LINK interface 77. The technique for inputting the acquired image data is not limited to the above-described ones. Provided that both the digital television broadcast receiving apparatus 100 and the image acquisition apparatus 200 are compatible with radio communication such as Bluetooth (registered trademark), the acquired image data stored in the image acquisition apparatus 200 may be input to the digital television broadcast receiving apparatus 100 by radio.

When acquired image data is input (BLOCK 5, YES), the controller 65 controls the display of the acquired image data. In response, the video processing module 65 generates a video based on the acquired image data. The video display 14 shows the generated video (BLOCK 6). The controller 65 further controls the display of a guidance screen for the specification of a screen position. In response, the video display 14 shows the guidance screen for the specification of the screen position (BLOCK 7).

For example, as shown in FIG. 4, the guidance screen on the video display 14 shows the text “Point to any position on the television screen”. Alternatively, the guidance screen on the video display 14 may show the text “Use the cross key on the remote controller to move the pointer on the screen up, down, left, or right to specify the screen position”. The dotted line in FIG. 4 indicates a guidance or the like displayed in the reference image. The user uses the remote controller 17 to specify the screen position (the position of the reference image) in the video displayed on the video display 14.

Once the screen position is specified (BLOCK 8, YES), the controller 65 detects the specified position to acquire video data (the acquired image of the reference image [Rs, Gs, Bs]) on the specified position (BLOCK 9). To inhibit the adverse effect of possible noise contained in the acquired image, averaged image data may be acquired instead of the video data on the specified position; the average image data is obtained by averaging the video data on the specified position and video data on a plurality of peripheral positions located on the right, left, top, and bottom of the specified position. For example, the averaged video data may be acquired by averaging video data on a 7×7 pixel matrix around the pixel at the specified position. If no position is specified for a given period (BLOCK 8, NO), the guidance screen is shown again on the video display 14 (BLOCK 7).

Subsequently, the controller 65 controls the display of the guidance screen for specification of a surrounding wall position. In response, the video display 14 shows the guidance screen for the specification of the surrounding wall position (BLOCK 10).

For example, as shown in FIG. 5, the guidance screen on the video display 14 shows the text “Point to any position on the surrounding wall”. Alternatively, the guidance screen on the video display 14 may show the text “Use the cross key on the remote controller to move the pointer on the screen up, down, left, or right to specify the surrounding wall position”. The dotted line in FIG. 5 indicates a guidance or the like displayed in the reference image. The user uses the remote controller 17 to specify the surrounding wall position in the video displayed on the video display 14.

Once the surrounding wall position is specified (BLOCK 11, YES), the controller 65 detects the specified position to acquire video data (the acquired image of the surrounding wall [Rw, Gw, Bw]) on the specified position (BLOCK 12). To inhibit the adverse effect of possible noise contained in the acquired image, averaged image data may be acquired instead of the video data on the specified position; the average image data is obtained by averaging the video data on the surrounding wall position and video data on a plurality of peripheral positions located on the right, left, top, and bottom of the surrounding wall position. For example, the averaged video data may be acquired by averaging video data on a 7×7 pixel matrix around the pixel at the specified position. If no position is specified for a given period (BLOCK 11, NO), the guidance screen is shown again on the video display 14 (BLOCK 11).

In the above-described case, the screen position and the surrounding wall position are specified by the user. However, the digital television broadcast receiving apparatus 100 may use an image processing technique to automatically detect the screen position and the surrounding wall position.

Subsequently, based on the reference image (Rref, Gref, Bref), the acquired image of the reference image (Rs, Gs, Bs), and the acquired image of the surrounding wall (Rw, Gw, Bw, the controller 65 and the video processing module 62 corrects an output image output by the video display 14. The reference image (Rref, Gref, Bref) and the acquired image of the reference image (Rs, Gs, Bs) originally need to be the same. However, as described above, the acquired image data obtained by the image acquisition apparatus 200 has been subjected to the image correction. Thus, there is a difference between the reference image (Rref, Gref, Bref) and the acquired image of the reference image (Rs, Gs, Bs). The difference is used to correct the output image output by the video display 14. The correction of the output image will be described below in detail.

For example, the controller 65 calculates the difference (Rref-Rs, Gref-Gs, Bref-Bs→ΔR, ΔG, ΔB) between the reference image (Rref, Gref, Bref) and the acquired image of the reference image (Rs, Gs, Bs) (BLOCK 13). The controller 65 further adds the difference (ΔR, ΔG, ΔB) to the acquired image of the surrounding image (Rw, Gw, Bw) (Rw+ΔR, Gw+ΔG, Bw+ΔB→Rws, Gws, Bws) (BLOCK 14). Alternatively, the controller 65 subtracts the difference (ΔR, ΔG, ΔB) from the acquired image of the surrounding image (Rw, Gw, Bw) (Rw-ΔR, Gw-ΔG, Bw-ΔB→Rws, Gws, Bws) (BLOCK 14). Thus, the color data (Rws, Gws, Bws) on the surrounding wall is obtained. The controller 65 generates correction data on the output image based on the color data (Rws, Gws, Bws) on the surrounding wall (BLOCK 15). Based on the correction data, the video processing module 62 corrects the contrast, brightness, color amplitude, hue, color temperature, and gamma value of the output image (BLOCK 16). Thus, the digital television broadcast receiving apparatus 100 can provide an output image with the adverse effect of possible optical illusion caused by the color of the surrounding wall reduced.

A color and the brightness of the color perceived by the human eye may vary depending on a color adjacent to this color. While the viewer is watching a video on the digital television broadcast receiving apparatus 100, not only the screen (video) but also the surrounding situation is in view even though the viewer does not recognize that the viewer is seeing the surrounding situation. In particular, the color of the wall is in view. The surrounding situation varies depending on the site where the digital television broadcast receiving apparatus 100 is installed. The digital television broadcast receiving apparatus 100 can absorb variation in the manner in which the screen appears, which variation is associated with the variation in installation site, to display the proper image according to the installation site.

A sensor or the like built into the digital television broadcast receiving apparatus 100 has difficulty sufficiently detecting the color of the wall or the like, which comes into view simultaneously with the video from the digital television broadcast receiving apparatus 100. Thus, the image acquisition apparatus 200 such as a digital camera or a cellular phone is used to acquire acquired image data including the videos of the digital television broadcast receiving apparatus 100 can use the acquired image data to correct the output image. This allows the output image to be relatively inexpensively corrected.

For example, it is assumed that the digital television broadcast receiving apparatus 100 (video display 14) is installed in front of a pale blue wall. Under this condition, when the digital television broadcast receiving apparatus 100 (video display 14) displays a single white image, the single white image appears bluish to the human eye. Under these conditions, when the above-described output image correction is applied, gain adjustment including gamma adjustment for RGB is performed to set the gain for blue to be lower than the gains for green and red. Thus, white can be adjusted such that when the digital television broadcast receiving apparatus 100 is installed against a pale blue wall, the actual white is perceived to be correct.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodiment in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image display apparatus comprising:
a display module configured to display an image;
a reference image display controller configured to control display of a reference image performed by the display module;
a reader configured to read acquired image data including the reference image displayed by the display module and an image of a surrounding area of the display module; and
a correction module configured to detect the acquired images of the reference image and the surrounding area in the acquired image data and to correct an output image output by the display module based on the reference image, the acquired image of the reference image, and the acquired image of the surrounding area.

2. The apparatus of claim 1, wherein the reference image display controller is configured to control display of a white reference image serving as the reference image.

3. The apparatus of claim 1, wherein the correction module is configured to correct color components of the output image output by the display module based on color components of the reference image, color components of the acquired image of the reference image, and color components of the acquired image of the surrounding area.

4. The apparatus of claim 1, wherein the correction module is configured to calculate a difference between the reference image and the acquired image of the reference image and to correct the output image output by the display module based on the difference and the acquired image of the surrounding area.

5. The apparatus of claim 4, wherein the correction module is configured to detect a surrounding color based on the difference and the acquired image of the surrounding area and to correct the output image output by the display module based on the surrounding color.

6. The apparatus of claim 1, wherein the correction module is configured to detect the acquired image of the reference image in a position specified as the reference image and to detect the acquired image of the surrounding area in a position specified as the image of the surrounding area.

7. The apparatus of claim 1, further comprising an image correction mode execution module configured to execute an image correction mode,
wherein the reference image display controller is configured to control the display of the reference image based on the execution of the image correction mode, the reader is configured to read the acquired image data based on the execution of the image correction mode, and the correction module is configured to correct the output image based on the execution of the image correction mode.

8. A method for correcting an output image, the method comprising:
allowing a display section to display a reference image;
reading acquired image data including the reference image displayed by the display section and an image of a surrounding area of the display module; and
detecting the acquired images of the reference image and the surrounding area in the acquired image data and correcting an output image output by the display section based on the reference image, the acquired image of the reference image, and the acquired image of the surrounding area.
